(19) United States
(12) Patent Application Publication
(10) Pub. No.: US 2002/0174309 A1
(43) Pub. Date: Nov. 21, 2002

(54) Protection against abusive use of a statement in a storage unit

(76) Inventors: David Naccache, Paris (FR); Pascal Paillier, Paris (FR)

Correspondence Address: BURNS DOANE SWECKER & MATHIS L L P, POST OFFICE BOX 1404, ALEXANDRIA, VA, 22313-1404, US

(21) Appl. No.: 10/130,943

(22) PCT Filed: Sep. 26, 2001
(86) PCT No.: PCT/FR01/02982

(30) Foreign Application Priority Data
Sep. 27, 2000 (FR) 00/12487

(51) Int. Cl. G06F 12/14; G06F 12/00

(52) U.S. Cl. 711/163; 711/103

(57) ABSTRACT

An operational instruction (Adrm) of the data reading, writing or modification type, or transaction, in a ROM memory (ME) of a microcontroller (CP) may be attacked by a command (COM) from a EEPROM memory (MC) of the microcontroller in order to access a secret data item (DS) instead of a public data item (CB), in response to an end instruction (Adr(m+3)). A test (Adr(m+1)) is immediately executed following an operational instruction (Adrm) in order to protect the latter. The test condition such as comparison is related to at least one operand (DPTR) of the said operational instruction. The result (CB) of the operational instruction is transferred to the EEPROM memory only when the condition is satisfied.

The present invention relates to in general terms protection against the improper, that is to say unauthorised, use of a sensitive instruction recorded in a memory. More particularly, it relates to protection against writing, reading or modification of a secret data item in the read only memory ROM of a microcontroller for example located in a smart card, also referred to as a microcontroller, or any other portable electronic object.

Many smart cards may contain sensitive data or programs, knowledge of which results in discovering the industrial know-how of the manufacturer and programming techniques or tools, such as APIs (Application Programming Interfaces). Very often, a smart card refers to a security matrix according to which any access in read mode, particularly to data in the ROM memory, is inhibited by instructions located in the non-volatile EEPROM memory or the RAM memory of the microcontroller of the card, or in any other RAM memory to which the microcontroller is connected, for example a RAM memory external to the card and included in the terminal accepting the card. Under these circumstances, reading data in the ROM memory is apparently possible only by means of instructions written in the ROM memory itself.

However, a hacker who has had knowledge of the address of an instruction which gives access to or modifies a secret data item, is capable of recovering the secret data item.

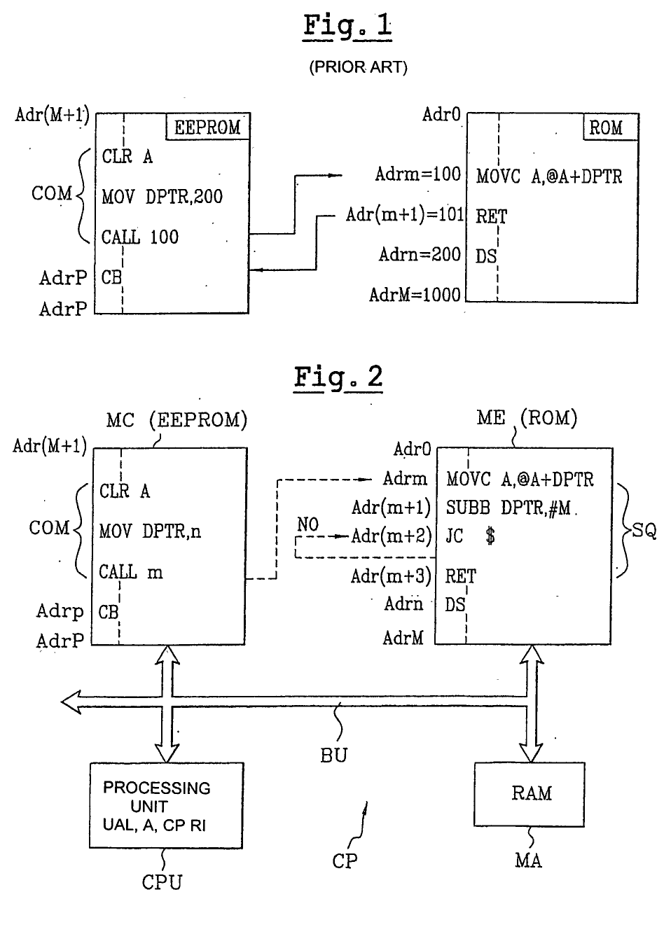

In order to illustrate this possibility, FIG. 1 shows an example of partial contents of the EEPROM memory and of the ROM memory in a microcontroller according to the prior art containing an 80C51 microprocessor from INTEL (registered trade mark). The count of the program counter of the microcontroller varies for example from Adr0=0 to AdrM=1000 for addresses of boxes contained in the ROM memory and Adr(M+1)=1001 to AdrP=2000 for addresses of boxes contained in the EEPROM memory, with M<<P. The value of a data pointer DPTR in the memories can thus vary between 0 and P.

It is assumed that, in the ROM memory, a “dangerous” instruction [MOVC A,@A+DPTR] positioned at the address Adrm=100 corresponds to the movement of a “public” data item, such as a code byte CB, pointed to in the EEPROM memory by the current value of the pointer DPTR, in order to transfer the data item to the accumulator A in the central processing unit (CPU) of the microcontroller. The data item CB is written at the address Adrp, with M+1≦p≦P. A return instruction RET is positioned at the address Adr(m+1) in the ROM memory and thus immediately follows the movement instruction MOVC.

In the normal absence of any attacker's sequence COM in the EEPROM memory, the pointer DPTR has received the value p following the running of a first part of the program (not shown) written in the memories, notably at addresses of the ROM memory preceding the address Adrm. The operational instruction MOVC at the address Adrm is executed in order to read and transfer into the accumulator A the data item CB which is used during a second program part following on from the return instruction RET.

A hacker who attempts to take cognisance of a secret data item DS positioned at the address Adrn in the ROM memory, for example with m+1<n=200<M, and who has had knowledge moreover of the address Adrm of the instruction MOVC, writes a short execution command sequence COM in the EEPROM memory in order to modify the pointer DPTR to the required value n. The sequence COM comprises three successive instructions. The first instruction [CLR A] sets the content of the accumulator A to zero. The second instruction [MOV DPTR,n] sets the data pointer DPTR to the value n corresponding to the address Adrn. The third instruction [CALL m] invokes a procedure call for directly executing the instruction MOVC at the address Adrm in the ROM memory.

The pointer DPTR with the value n which pointed to the data DS at the address Adrn during the execution of the “dangerous” instruction invoked, the required secret data item DS is transferred into the accumulator A and is easily recoverable by the hacker. After the return instruction RET, the execution of any instruction, for example [MOVX @Ri,A], following the call instruction [CALL m] and written in the EEPROM memory by the hacker, enables him to obtain the secret data item DS read in ROM memory by emptying the content of the accumulator, for example in an external RAM memory, outside the microcontroller.

The present invention aims to inhibit this type of threat without preventing the writing of “dangerous”instructions in the ROM memory, in order to prevent the improper use of the result of such a dangerous instruction.

To this end, a method for protecting an operational instruction included in a sequence of instructions written in a memory means against an execution command from a control means for accessing the result of the operational instruction executed, in response to an end of sequence instruction, is characterised in that the sequence comprises a test immediately executed following the operational instruction on a condition related to at least one operand of the said operational instruction, a transfer of the result of the operational instruction executed from the memory means to the control means when the condition is satisfied, and a non-execution of the end of sequence instruction when the condition is not satisfied.

According to a first embodiment, the test comprises a calculation, such as difference, depending on the operand and a predetermined value, the condition being a comparison of the result of the calculation with at least one predetermined threshold, such as the value zero. The result of the operational instruction is then transferred to the control means when the result of the calculation is included in a first range having the threshold as one of the bottom and top limits, and the end instruction is not executed when the calculation result is included in a second range having the threshold as the other of the bottom and top limits of this second range. The operational instruction can be a reading, writing or modification of a data item in the memory means, and the operand can be a data address pointer. The non-execution of the end instruction can result from a jump of an instruction to itself executed following the non-satisfaction of the condition, or conventionally an error message or a card reject.

According to a second embodiment, the operational instruction is a transaction, and the condition of the test is authorisation of the transaction. Preferably the operational instruction is the modification of a balance following the reading thereof in the control means, the condition is applied to the balance or a balance increment, and the transfer comprises a writing of the modified balance from the memory means in the control means.

The invention also relates to a portable electronic object comprising a microcontroller whose non-rewritable memory on the one hand and whose programmable non-volatile memory and/or random access memory on the other hand are included respectively in the memory means and the control means for implementing the method according to the invention. In particular, at least one of the operational instructions written in the non-rewritable memory for reading, writing or modifying a data item in the non-volatile memory and/or the random access memory is followed immediately by a test written in the non-rewritable memory, on a condition related to at least one operand of the said operational instruction, in order to invalidate the object when the condition is not satisfied.

Other characteristics and advantages of the present invention will emerge more clearly from a reading of the following description of several preferred embodiments of the invention with reference to the corresponding accompanying drawings, in which:

FIG. 1 shows an attack written in a EEPROM memory, on a sequence written in a ROM memory illustrating the prior technique already commented on;

FIG. 2 is a block diagram of a smart card in which the attacked sequence written in ROM memory is modified according to the protection method of the invention for a first embodiment;

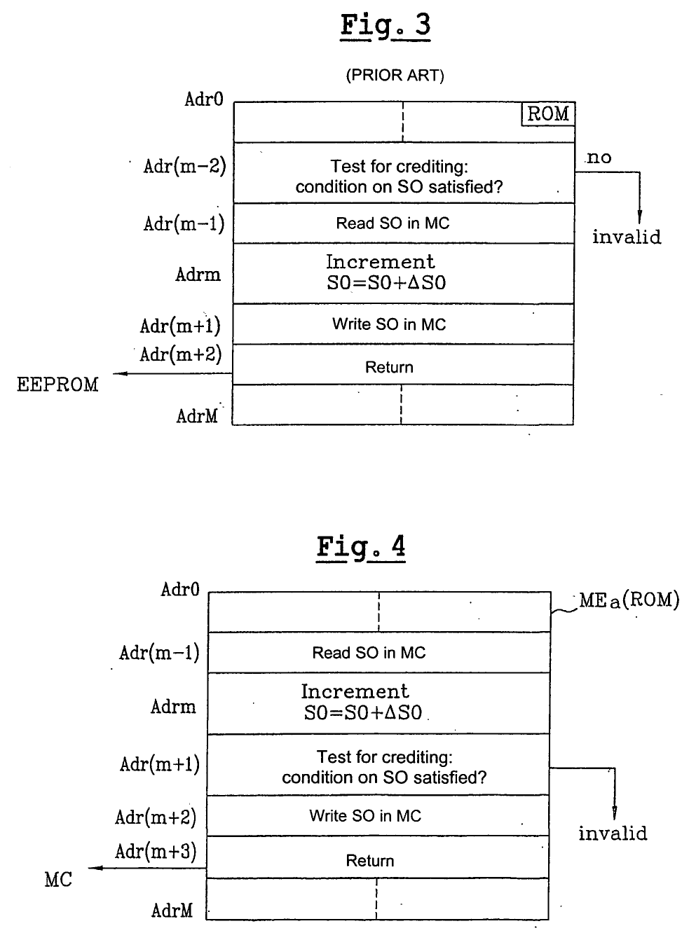

FIG. 3 shows the instructions of a “dangerous” sequence written in ROM memory according to a second known embodiment; and

FIG. 4 shows the “modified dangerous” sequence modified according to the protection method of the invention relative to the second embodiment.

With reference to FIG. 2, it is assumed, as with FIG. 1, that a microcontroller, in particular a smart card CP, or any other portable electronic object, contains a processing unit CPU consisting in practice of a microprocessor of the aforementioned 80C51 type. The unit CPU includes in particular an arithmetic logic unit UAL with in particular an accumulator A, an instruction address counter CP and a current instruction register RI. The microcontroller also conventionally comprises a non-rewritable memory ME of the ROM type, a memory MC of the programmable nonvolatile type EEPROM, and a memory MA of the random access type RAM in order to exchange data with the world external to the microcontroller, such as a terminal accepting the smart card CP.

The memories interact with the processor CPU during the running of a program or application written at least partly in ROM memory and partly in EEPROM memory, by means of requests and responses, containing “results” of instructions executed, through a bus BU.

According to the first embodiment illustrated in FIG. 2, the execution command sequence COM is found with three instructions written by a hacker in the EEPROM memory MC which constitutes according to the invention a control means which is able to access the result of a “dangerous” operational instruction invoked in the memory ME. The three instructions thus relate to the erasure of the content of the accumulator A, to the setting of the memory pointer DPTR to the value n of the address Adrn relating to the secret data DS in the memory ME, and to the invoking of the instruction deemed to be “dangerous” written in the box m at the address Adrm in the ROM memory.

Compared with the content of the ROM memory in FIG. 1, the instruction sequence SQ in the memory ME has been supplemented so that the execution of the end instruction RET of the sequence SEQ for once again executing instructions in the memory MC are conditional upon a test on a condition applied to an operand of the previous dangerous instruction pointed to the address Adrm. This additional sequence essentially comprises the following two instructions:

SUBB DPTR,#M

JC $

written in the memory ME at the successive addresses Adr(m+1) and Adr(m+2) immediately after the “dangerous” instruction [MOVC A,@A+DPTR] and before the instruction RET now written at the address Adr(m+3).

The first additional instruction SUBB subtracts the value M from the highest address AdrM in the memory ME, at the last value of the pointer DPTR, in this case the one used normally for pointing to the data item CB read in the memory MC at the time of execution of the previous operational instruction MOVC.

The second additional instruction JC is a conditional instruction “SI” (IF) with carry effecting an address jump according to the result of the previous subtraction DPTR=DPTR−M.

If the difference DPTR-M is negative, in particular in response to the call instruction [CALL m] of the hacker which set the value of the pointer DPTR to a value n less than M, the instruction JC at the address Adr(m+2) jumps on itself and imposes an infinite loop in the ROM memory, as indicated in dotted lines. This loop, reiterated infinitely, prevents the non-execution of the following end instruction RET and is consequently inhibits the recovery of the data item DS from the accumulator by the hacker.

On the other hand, if the last value of the pointer DPTR is higher than the maximum value M of the addresses of the memory ME, that is to say equal to a value such that M+1≦p≦P and designating a public data box in the memory MC, the difference DPTR-M is positive. The instruction JP makes the sequence of the instruction SUBB of address Adr(m+1) jump to the end instruction RET of address Adr(m+3) so as to pursue the current program.

In a variant, instead of the “dangerous” operational instruction in the address box Adrn executing a data reading, it executes a data writing, or even any data modification.

According to yet other variants, the additional instructions in the address boxes Adr(m+1) and Adr(m+2) are replaced by a comparison of the pointer DPTR with two values MIN and MAX of the two addresses of the memory ME designating boxes in which a memory space contains confidential data to be protected. Any pointer value between MIN and MAX, attempted by a hacker, leads to the infinite loop JC.

In the above description, it will be understood that the smart card CP covers all known types of smart card, also known as microcontroller cards, such as the contact or contactless cards mentioned hereinafter by way of non-limitative example: credit cards, payment cards, prepaid cards, telephone cards, SIM cards, “additional” cards, central purchasing cards, game cards, etc. More generally, the invention not only relates to smart cards but also other portable electronic objects designated indifferently by electronic data processing means, such as electronic assistants or organisers, electronic purses, tokens, pocket calculators, etc.

According to a second known embodiment shown in FIG. 3, the ROM memory contains, in four successive address boxes Adr(m−1), Adrm, Adr(m+1) and Adr(m+2), instructions of a transaction sequence concerning the reading of a balance SO from the EEPROM memory to the ROM memory, the incrementation of the balance with a selected increment ΔSO, the writing of the incremented balance SO=SO+ΔSO from the ROM memory into the EEPROM memory, and finally the end of sequence instruction Return generally followed by the removal of the smart card from the accepting terminal.

The ROM and EEPROM memories are included in a smart card serving as an electronic purse for this second embodiment.

According to the prior art, the balance incrementation sequence is preceded at the box address Adr(m−2) by a test for authorising the credit operation consisting of a condition related to at least the balance operand SO and/or the increment operand ΔSO included in the credit operation, essentially the operational incrementation instruction SO=SO+ΔSO.

The test verifies that the purse is in a normal or abnormal operating context. For example, the condition may be that the balance of the bank account of the owner of the electronic purse is greater than the increment ΔSO, or may be that the increment ΔSO is less than an upper limit, and/or that the sum of such incrementations during a predetermined period is less than a maximum authorised credit. The verification of the condition may be preceded by an identification of the user and/or an authentication of the electronic purse through a dialogue with the point of sale accepting terminal of a shopkeeper, and/or a bank server.

If a hacker knows the address Adr(m−1) of the box in the ROM memory containing the balance reading instruction, the hacker can thus increment the balance with the increment of his choice, despite the satisfying of the test condition Adr(m−2) at a previous step, and recover the electronic purse credited with the instruction Return. At worst, the hacker can write a sequence in the EEPROM memory MC which reiterates the sequence of instructions Adr(m−1) to Adr(m+2) as many times as the hacker wishes.

According to the invention with reference to FIG. 4, so as to prevent the execution of this transaction sequence in the ROM memory MEa being able to be controlled by a hacker by means of a program written in the EEPROM memory MC, the invention protects this sequence by introducing the test for crediting into the memory MEa.

Thus, immediately after the “dangerous” operational incrementation instruction at the address Adrm, the following address box Adr(m+1) contains the test for example identical to that already presented with reference to FIG. 3, or a test on a condition related to the operand consisting of the result SO=SO+ΔSO, such as a comparison with an upper limit, and an owner identification.

If the conditional instruction Adr(m+1) is not satisfied, the following instructions at the addresses Adr(m+2) and Adr(m+3) are not executed. No incremented balance is written in the EEPROM memory MC, and the sequence is switched to the transmission of an error message or the like in order to invalidate the electronic purse and possibly eject it out of the accepting terminal.

On the other hand, if the conditional instruction Adr(m+1) is satisfied, the incremented balance SO is written in the memory MC according to the instruction at the address Adr(m+2) and the program is continued after the end of sequence instruction Return at the address Adr(m+3).

Although the above description refers to a data item CB normally to be read in the non-volatile EEPROM memory MC by the “dangerous” instruction written at the address Adrm in the non-rewritable ROM memory ME, the control means within the meaning of the invention can include not only the EEPROM memory MC but also the random access memory RAM MA of the microcontroller.

1. A method for protecting an operational instruction (Adrm) included in a sequence of instructions (SQ) written in a memory means (ME) against an execution command (COM) from a control means (MC) for accessing the result of the operational instruction executed, in response to an end of sequence instruction (Adr(m+3)), is characterised in that the sequence comprises a test (Adr(m+1), Adr(m+2)) immediately executed following the operational instruction (Adrm) on a condition related to at least one operand (DPTR) of the said operational instruction, a transfer (RET) of the result (CB) of the operational instruction executed from the memory means (ME) to the control means (MC) when the condition is satisfied, and a non-execution of the end of sequence instruction (Adr(m+3)) when the condition is not satisfied.

2. A method according to claim 1, according to which the test comprises a calculation depending on the operand and a predetermined value (M), the condition being a comparison of the result of the calculation with at least one predetermined threshold.

3. A method according to claim 1 or 2, according to which the operational instruction (Adrm) is a reading, writing or modification of a data item (CB) in the control means (MC), and the operand is a data address pointer (DPTR).

4. A method according to any one of claims 1 to 3, according to which the non-execution of the end instruction (Adr(m+3)) results from a jump (JC) of an instruction to itself executed following the non-satisfaction of the condition.

5. A method according to claim 1, according to which the operational instruction (Adrm) is a transaction, and the test condition (Adr(m+1)) is an authorisation for the transaction.

6. A method according to claim 5, according to which the operational instruction (Adrm) is the modification of a balance (SO) following on from a reading (Adr(m−1)) thereof in the control means (MC), the condition is applied to the balance or a balance increment (ΔSO), and the transfer comprises a writing (Adr(m+2)) of the modified balance from the memory means (MEa) in the control means.

7. A portable electronic object comprising a microcontroller (CP), characterised in that a non-rewritable memory of the microcontroller and a nonvolatile programmable memory and/or a random access memory (MA) of the microcontroller are included respectively in the memory means (ME) and the control means (MC) for implementing the method according to any one of claims 1 to 6.

8. An object according to claim 7, in which at least one of the operational instructions (Adrm) written in the non-rewritable memory for reading, writing or modifying a data item in the non-volatile memory (MC) and/or the random access memory is followed immediately by a test (Adr(m+1), Adr(m+2)) written in the non-rewritable memory, on a condition related to at least one operand of the said operational instruction, in order to invalidate the object when the condition is not satisfied.
